(19) United States
(12) Patent Application Publication
(10) Pub. No.: US 2017/0339963 A1
(43) Pub. Date: Nov. 30, 2017

(54) Biopesticide composition for use in preventing or minimizing plant disease

(71) Applicant: Agro Research International, LLC, Sorrento, FL (US)

(72) Inventor: Marc Lajeunesse, Sorrento, FL (US)

(21) Appl. No.: 15/607,043

(22) Filed: May 26, 2017

Related U.S. Application Data
(60) Provisional application No. 62/342,636, filed on May 27, 2016.

(51) Int. Cl. A01N 63/00

(52) U.S. Cl. CPC A01N 63/00; C12Y 302/01014

(57) ABSTRACT

A biopesticide composition and method of treating plants or plant components comprising a first component having bacillus and a second component having a polysaccharide. Preferably, the bacillus strain is Bacillus chitinosporus. In combination, the biopesticide composition can be applied to plants to minimize or prevent plant diseases associated with nematodes.

### CROSS REFERENCE

In accordance with 37 C.F.R. 1.76, a claim of priority is included in an Application Data Sheet filed concurrently herewith. Accordingly, the present invention claims priority to U.S. Provisional Application No. 62/342,636 “BIOPESTICIDE COMPOSITION FOR USE IN PREVENTING OR MINIMIZING PLANT DISEASE”, filed May 27, 2016. The contents of the above referenced application are incorporated herein by reference in its entirety.

### FIELD OF THE INVENTION

The present invention relates to a composition for preventing or minimizing plant disease; to a composition and method of using the composition, containing a bacterial strain and a polysaccharide for preventing or minimizing plant disease associated with plants and crops; and more importantly, to a composition and method of using the composition, containing bacillus and chitosan for preventing or minimizing plant disease associated with nematodes.

### BACKGROUND OF THE INVENTION

The ability to provide and obtain food is an essential human requirement. The production of fruits and vegetables is critical, both as an economic component and as a human sustainability component. Cultivating and the production of commercial products, such as citrus, play an important role in the economies of areas that produce such products. The state of Florida, for example, relies heavily on the production of citrus. Florida's citrus industry is a multibillion dollar industry employing tens of thousands of individuals. A recent threat to the industry as a whole is a bacterial disease known as citrus greening. While Florida's orange industry has weathered hardships associated with canker disease, hurricanes, and hard freezes, citrus greening has the potential to devastate the industry. This disease is spread by Asian citrus psyllids, with no known cure available. With no effective cure, diseased trees fail to provide edible fruits and are an economic loss. Should an orange grove contain widespread disease, the overall effect could result in economic devastation for the grower.

While most fruit or vegetable growers do not encounter such devastating diseases, various natural microbes can affect crop yield if they are not properly controlled. Plant parasitic nematodes are microscopic round worms found in soil which attack plants, thereby causing crop loss. While not all nematodes are parasitic, those that are generally attack the roots of a plant. Attacking the plant's roots results in root dysfunction and reduction of water and nutrient utilization. Several options are available for managing parasitic nematode problems, including rotation with less susceptible crops or resistant varieties, use of transplants, preplant nematicide treatments, or use of natural antagonists. These solutions are not without negative consequences, including cost and time, and they can have negative effects on beneficial soil organisms. Each of these strategies relies on prevention, as once a plant is infected with the nematode, killing the parasite is impossible without killing the host plant as well.

Accordingly, there is a need in the art for an effective composition, and method of using the composition, to treat diseases associated with plants, such as nematode related disease, which is effective and does not damage the host plant.

### SUMMARY OF THE INVENTION

The present invention provides a biopesticide composition, referred to sometimes as a/the composition, and method of use of the biopesticide composition, for the prevention or minimization of diseases in plants, such as plant diseases associated with nematodes. The composition for treating diseases in plants associated with nematodes of the present invention uses primarily two components, one or more strains of microbial strains, preferably a bacteria strain having chitinase activity, in combination with a substrate that can be used by the one or more bacterial strains to produce chitinase. Preferably, the bacterium is a strain of bacillus. The substrate used by the one or more bacterial strains to produce chitinase may be a chitosan-chitin based material, such as chitosan or chitan.

In one illustrative embodiment, the invention provides for a composition for preventing or minimizing plant disease comprising at least one microbial strain with chitinase activity; and a substrate that stimulates production of chitinase enzyme, which, in combination with the at least one microbial strain, prevents or minimizes plant or crop disease.

In one illustrative embodiment, the invention provides for a composition for preventing or minimizing plant disease comprising a bacterial strain of Bacillus; and a polysaccharide, which in combination with the bacterial strain of Bacillus, prevents or minimizes plant or crop disease.

In another illustrative embodiment, the invention provides for a composition for preventing or minimizing plant disease comprising a bacterial strain of Bacillus chitinosporus, and a polysaccharide, which in combination with the Bacillus chitinosporus, kills or prevents the growth of at least one nematode species associated with plant disease.

In another illustrative embodiment, the invention provides for a method of preventing or minimizing plant disease comprising applying an effective amount of a composition to a plant or plant component to minimize or prevent plant or crop disease, said composition comprising at least one microbial strain with chitinase activity; and a substrate that stimulates production of chitinase enzyme.

In another illustrative embodiment, the invention provides for a method of producing substances which kill or inhibit nematodes comprising applying an effective amount of a composition to a plant or plant component to minimize or prevent plant or crop disease, said composition comprising at least one microbial strain with chitinase activity; and a substrate that stimulates production of chitinase enzyme, whereby a concentration of substrate that stimulates production of chitinase enzyme is sufficient to allow the at least one microbial strain with chitinase activity to produce chitinase enzyme in a sufficient concentration or quantity to kill or inhibit nematodes associated with plants that contain the composition applied thereto.

In another illustrative embodiment, the invention provides for a method of preventing or minimizing plant disease comprising applying an effective amount of a composition to a plant or plant component to minimize or prevent plant or crop disease, said composition comprising a bacterial strain of Bacillus and a polysaccharide. The method may also include monitoring the plant or plant component for improvement of plant disease, and reapplying the composition if necessary for treatment of said plant disease in said plant or plant component.

Accordingly, it is an objective of the invention to provide a composition for preventing or minimizing plant disease.

It is a further objective of the invention to provide a method of preventing or minimizing plant disease.

It is another objective of the invention to provide a composition for preventing or minimizing plant disease associated with nematodes.

It is a further objective of the invention to provide a method of preventing or minimizing plant disease associated with nematodes.

It is yet another objective of the invention to provide a composition for preventing or minimizing plant disease having a bacterial species in combination with a substrate that stimulates production of chitinase enzyme.

It is a further objective of the invention to provide a composition for preventing or minimizing plant disease having a bacterial component in combination with a substrate that stimulates production of chitinase enzyme.

It is a still further objective of the invention to provide a method of preventing or minimizing plant disease using a composition having a bacterial species in combination with a substrate that stimulates production of chitinase enzyme.

It is a still further objective of the invention to provide a method of preventing or minimizing plant disease using a composition having a bacterial species with chitinase activity in combination with a substrate that stimulates production of chitinase enzyme.

It is a still further objective of the invention to provide a method of preventing or minimizing plant disease using a composition having a chitinolytic bacteria capable of decomposing chitin or chitosan through production of chitinase enzyme, in combination with a substrate that stimulates production of chitinase enzyme.

It is a further objective of the invention to provide a composition for preventing or minimizing a plant disease using a composition having bacillus in combination with a substrate that stimulates production of chitinase enzyme.

It is a further objective of the invention to provide a composition for preventing or minimizing a plant disease using a composition having bacillus chitinosporus in combination with a substrate that stimulates production of chitinase enzyme.

It is yet another objective of the invention to provide a composition for preventing or minimizing a plant species having a bacterial species in combination with chitosan or chitin.

It is a still further objective of the invention to provide a composition for preventing or minimizing plant disease using a composition having bacillus chitinosporus in combination with chitosan or chitin.

It is a further objective of the invention to provide a method of preventing or minimizing plant disease using a composition having bacillus chitinosporus in combination with chitosan or chitin.

Other objectives and advantages of this invention will become apparent from the following description taken in conjunction with any accompanying drawings wherein are set forth, by way of illustration and example, certain embodiments of this invention. Any drawings contained herein constitute a part of this specification and include exemplary embodiments of the present invention and illustrate various objects and features thereof.

### DETAILED DESCRIPTION OF THE INVENTION

While the present invention is susceptible of embodiment in various forms, there is shown in the drawings and will hereinafter be described a presently preferred, albeit not limiting, embodiment with the understanding that the present disclosure is to be considered an exemplification of the present invention and is not intended to limit the invention to the specific embodiments illustrated.

The present invention provides a biopesticide composition, and method of use of the biopesticide composition, for the prevention of diseases in plants associated with nematodes. The composition of the present invention uses primarily two components to prevent or minimize diseases in plants associated with nematodes. The first component includes one or more strains of bacteria. Preferably, the bacteria strain is one with chitinase activity or capable of enzymatic actions through chitinases. Accordingly, the bacteria strain may be a chitinolytic bacteria capable of decomposing chitin or chitosan. Preferably, the bacterial strain component is bacillus, and more preferably, bacillus chitinosporus. The second component is a substrate that stimulates the growth of the bacteria or, and more preferably, stimulates the production of chitinase. The second component includes a chitosan-chitin based material.

The composition provides at least one microbial strain with chitinase activity, in combination with a substrate or material which produces or enhances the production the chitinase. As the microbial composition interacts with the supplied concentration of the chitosan-chitin based material, a source of chitinase enzyme can be continuously produced and viable to act on nematodes. The composition therefore includes a concentration of chitosan-chitin based material sufficient enough to allow the microbial strain(s) to produce chitinase in a concentration sufficient enough to act on, i.e. kill or inhibit growth, of nematodes in contact with the enzymes. Accordingly, the concentration of both components of the biopesticide composition is sufficient enough so that chitinase enzyme is produced in a sufficient concentration to kill or inhibit nematode production.

The biopesticide composition can be prepared in a liquid form. Alternatively, biopesticide composition can be prepared in a soluble, dry powder form. The biopesticide composition may be applied to any portion of a plant, preferably to the root system.

Microbial species having chitinase activity or capable of enzymatic actions through chitinases: The biopesticide composition may include one microbial strain or species, or a combination of strains or species.

Bacillus. Bacillus is a Gram-positive, rod shaped bacteria from the phylum Fimicutes. Bacillus is found in soil and water, and is generally an aerobic bacteria, but under certain conditions can be anaerobic. The preferred Bacillus species is an isolated or purified Bacillus Chitinosporus.

While commercially available Bacillus Chitinosporus (see, for example ATCC 19986) are known and could be used as the first component biopesticide composition, the Bacillus Chitinosporus, referred to herein as Bacillus chitinosporus var. 101, used in the following experiments was originally isolated from agriculture soil from a cotton field near Kingsville, Tex. (Kleberg County). The soil was sampled. Microorganisms were isolated and characterization studies were conducted. After biochemical and enzymatic characterization, Bacillus chitinosporus var. 101 was selected, assayed and cultured. Bacillus chitinosporus var. 101 is a gram positive, endospore-forming, motile bacterium that prefers mesophilic growth conditions at a pH range of 3-11.

The bacterium produces and secretes a high concentration dose of the enzyme chitinase, which is an enzyme that selectively targets chitin in the environment. Chitin is a fundamental component of fungal cell walls and nematode larval cysts. Therefore, it is believed that once Bacillus chitinosporus var. 101 secretes the extracellular chitinase enzyme, the enzyme will then degrade chitin complex polymers in its vicinity, which will thus reduce it into its simple components, thereby lysing the cell wall and exposing its intracellular components to the environment, leading to larval cell death. The nematode larvae will lyse due to osmotic pressure differences in the environment.

Bacillus chitinosporus var. 101, along with several other Bacillus species were tested to determine the amount of chitinase produced when combined with a chitosan-chitin based material. Table 1 illustrates test results which demonstrate the percentage (ppm) of the enzyme chitinase produced as a direct response to the substrate of chitosan-chitin based material, illustrated as chitin in the environment. Chitin was substituted for dextrose in a tryptic soy broth formulation (standard microbial growth media for facultative anaerobic cultures). No simple sugar was available and present for catabolism in the media. The only way that the organisms were able to grow in this environment was through catabolism of chitin (complex sugar polymer) as their ultimate sugar component. The enzyme chitinase was measured over time in a shake flask at 37° C. for each organism. Samples were taken of each organism from their individual flask, the media component was filtered out, and what was left over as the effluent was the chitinase enzyme. This was measured per each species in their individual flask. Concentrations are shown in the table assay.

TABLE 1
Chitinase enzyme production assay

| | Bacillus | Bacillus | Bacillus |
|---|---|---|---|
| | chitinosporus v 101 | subtillis | licheniformis |
| | Chitinase | Chitinase | Chitinase |
| | Concentration | Concentration | Concentration |
| DAY | (ppm)* | (ppm)* | (ppm)* |
| 1 | 32 | 2 | 3 |
| 3 | 95 | 21 | 15 |
| 5 | 185 | 35 | 40 |
| 7 | 355 | 44 | 48 |
| 9 | 430 | 55 | 51 |
| 12 | 505 | 60 | 55 |
| 14 | 405 | 85 | 75 |
| 16 | 315 | 98 | 115 |
| 18 | 255 | 55 | 125 |
| 20 | 190 | 40 | 85 |
| 22 | 165 | 25 | 45 |
| 24 | 115 | 15 | 30 |
| 26 | 85 | 3 | 22 |
| 28 | 35 | 3 | 22 |
| 30 | 6 | 2 | 15 |

*Spectrophtometric and colorimetric concentration analysis.

Tryptic Soy Broth media (substituted dextrose with chitin), 35° C., rotating shaking platform at 190 rpm with sparging oxygen, pH at 7.

As used herein, the term “chitosan-chitin based material” is defined as purified or isolated chitosan, purified or isolated chitin, chitin or chitosan derivative or a raw material which may include a source of chitosan or chitan which can be used by, or broken down by a bacteria species to utilize as a source of chitosan or chitan. If required, the isolated or pure chitosan or chitan may be mixed with a substrate to help solubility when mixed with other components of the invention. For example, chitosan acetate in solution may be used in the composition. As an illustrative example, the raw material may be a shrimp meal or shrimp waste meal, defined as the undecomposed waste of shrimp, preferably in a ground, dried state. The shrimp meal may contain whole shrimp or parts of shrimp, such as heads or shells. The shrimp meal may be manufactured using sun drying, oven drying, or may be boiled or steamed prior to drying. The shrimp meal can be made and used in a liquid form. Use of “chitosan-chitin based material” may also cover any other animal, or animal components, plant or fungi/fungal species that contain chitin or chitosan, such as the exoskeletons of insects, crabs, lobsters, or other crustacean shells. Arthopods or even mushrooms, whole or parts, may be used as well.

Chitin: is a linear, log chain polysaccharide composed of multiple β-(1-4)-linked D-glucosamine, having the formula of:

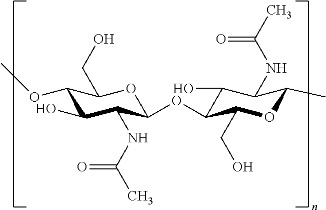

The above formula illustrates two of the N-acetyl-D-glucosamine units that repeat to form long chains in β-(1-4)-linkage.

Chitosan is a linear polysaccharide composed of randomly distributed β-(1-4) linked D-glucosamine and N-acetyl-D-glucosamine, and having the chemical formula of:

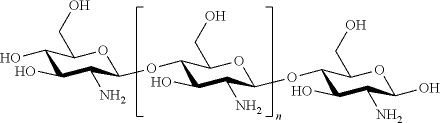

Chitosan can be obtained from the hard outer skeleton of shellfish, including crabs, lobster, or shrimp.

TABLE 2
Example 1. Composition for preventing or
minimizing plant disease associated with nematodes.

| Component | Concentration |
|---|---|
| Microbial Ingredients | Cell density of |
| | 1.0 × 10⁶ CFU/ml and up |
| Polysaccharide | 0.1-10% |

TABLE 3
Example 2. Composition for preventing or
minimizing plant disease associated with nematodes.

| Component | Concentration |
|---|---|
| Microbial component: | Cell density of |
| chitinolytic bacteria | 1.0 × 10⁶ CFU/ml and up |
| strain capable of degrading | |
| chitin | |
| Substrate that stimulates | 0.1-10% |
| the growth of chitinolytic | |
| bacteria or production of | |
| chitinase | |

TABLE 4
Example 3. Composition for preventing or
minimizing plant disease associated with nematodes.

| Component | Concentration |
|---|---|
| Microbial Ingredients | Cell density of |
| | 1.0 × 10⁶ CFU/ml and up |
| Chitosan-chitin based | 0.1-10% |
| material | |

TABLE 5
Example 4. Composition for preventing or
minimizing plant disease associated with nematodes.

| Component | Concentration |
|---|---|
| Microbial component: | Cell density of |
| bacteria species with | 1.0 × 10⁶ CFU/ml and up |
| chitinase | |
| activity/enzymatic action | |
| through chitinase; or | |
| chitinolytic bacteria | |
| Chitosan-chitin based | 0.1-10% |
| material | |

TABLE 6
Example 5. Composition for preventing or
minimizing plant disease associated with nematodes.

| Component | Concentration |
|---|---|
| Microbial Ingredients: | Cell density of |
| Bacillus | 1.0 × 10⁶ CFU/ml and up |
| Polysaccharide: Chitosan | 0.1-10% |

TABLE 7
Example 6 Composition for preventing or
minimizing plant disease associated with nematodes.

| Component | Concentration |
|---|---|
| Bacillus Chitinosporus | 1.0 × 10⁹ CFU/ml |
| Chitosan | 2.5% |

Initial Experiments: Inoculum of a bacterial species, preferably Bacillus, and more preferably Bacillus chitinosporus, is prepared having a cell density of, for example 1.0×10⁶ CFU/ml and up, preferably a cell density of 1.0×10⁹ CFU/ml. While commercially available Bacillus Chitinosporus are known and could be used as the first component biopesticide composition, the Bacillus Chitinosporus originally isolated from agriculture soil from a cotton field near Kingsville, Tex. (Kleberg County) was used. The soil was sampled. Microorganisms were isolated and characterization studies were conducted. After biochemical and enzymatic characterization, Bacillus chitinosporus var. 101 was selected, assayed and cultured. Bacillus chitinosporus var. 101 is a gram positive, endospore-forming, motile bacterium that prefers mesophilic growth conditions at a pH range of 3-11. The bacterium produces and secretes a high concentration dose of the enzyme chitinase, which is an enzyme that selectively targets chitin in the environment. Chitin is a fundamental component of fungal cell walls and nematode larval cysts. Therefore, it is believed that once Bacillus chitinosporus var. 101 secretes the extracellular chitinase enzyme, the enzyme will then degrade chitin complex polymers in its vicinity, which will thus reduce it into its simple components, thereby lysing the cell wall and exposing its intracellular components to the environment leading to larval cell death. The nematode larvae will lyse due to osmotic pressure differences in the environment.

To the bacteria inoculum, 0.1-10% chitosan-chitin based material, preferably 2.5% chitosan, is mixed to form a composition in accordance with Examples 1-6. The composition was applied to tomato plants. Soil samples were tested for the types (i.e. species) and number of each species found in order to determine the nematode load. Table 8 (below) illustrates initial experimental results for the tomato plants treated with the composition versus a control group in which tomato plants were not treated with the composition. The overall nematode load for the control group was 720 per 500 cc. The treated group had an overall nematode load of 8 per 500 cc. Table 5 (below) illustrates additional experimental results for the tomato plants treated with the composition applied versus a control group in which tomato plants were not treated with the composition. The overall nematode load for the control group was 864 per 500 cc. The treated group had an overall nematode load of 72 per 500 cc. Accordingly, the nematode load was reduced by 10 fold.

TABLE 8
Initial Experiment: Results 1: Determination
of the existence of nematode species and numbers in tomato
plants grown using the composition and those that do not.

| | | Total/500 cc- |
|---|---|---|
| | Total/500 cc | Tomato w/ |
| Nematode Species | Tomato-Control | Composition |
| Tylenchulus | 0 | 0 |
| semipenetrans (Citrus | | |
| nematode) | | |
| Belonolaimus Sp. | 16 | 0 |
| (Sting Nematode) | | |
| Xiphinema Sp. | 0 | 0 |
| (Dagger Nematode) | | |
| Pratylenchus coffeae | 0 | 0 |
| (Coffee Lesion Nematode) | | |
| Pratylenchus brachyurus | 0 | 0 |
| (Lesion Nematode) | | |
| Radopholus Sp. | 0 | 0 |
| (Burrowing Nematode) | | |
| Hoplolaimus Sp. | 0 | 0 |
| (Lance Nematode) | | |
| Criconema Sp. | 0 | 0 |
| (Ring Nematode) | | |
| Trichodorus | 8 | 8 |
| (Stubby Root Nematode) | | |
| Tylenchorynchus | 0 | 0 |
| (Stunt or Stylet | | |
| Nematode) | | |
| Helicotylenchus | 0 | 0 |
| (Spiral Nematode) | | |
| Hemicycliophora | 0 | 0 |
| (Sheath Nematode) | | |
| Meloidogyne | 696 | 0 |
| (Root Knot) | | |
| Nematode Load/All | 720 | 8 |
| Species Total/500 cc | | |

TABLE 9
Initial Experiment: Results 2: Determination
of the existence of nematode species and numbers in tomato
plants grown using the composition and those that do not.

| | | Total/500 cc- |
|---|---|---|
| | Total/500 cc | Tomato w/ |
| Nematode Species | Tomato-Control | Composition |
| Tylenchulus | 0 | 0 |
| semipenetrans (Citrus | | |
| nematode) | | |
| Belonolaimus Sp. | 130 | 48 |
| (Sting Nematode) | | |
| Xiphinema Sp. | 0 | 0 |
| (Dagger Nematode) | | |
| Pratylenchus coffeae | 0 | 0 |
| (Coffee Lesion | | |
| Nematode) | | |
| Pratylenchus brachyurus | 0 | 0 |
| (Lesion Nematode) | | |
| Radopholus Sp. | 0 | 0 |
| (Burrowing Nematode) | | |
| Hoplolaimus Sp. | 0 | 0 |
| (Lance Nematode) | | |
| Criconema Sp. | 0 | 0 |
| (Ring Nematode) | | |
| Trichodorus | 32 | 8 |
| (Stubby Root Nematode) | | |
| Tylenchorynchus | 0 | 0 |
| (Stunt or Stylet | | |
| Nematode) | | |
| Helicotylenchus | 0 | 0 |
| (Spiral Nematode) | | |
| Hemicycliophora | 0 | 0 |
| (Sheath Nematode | | |
| Meloidogyne | 696 | 16 |
| (Root Knot) | | |
| Nematode Load/All | 864 | 72 |
| Species Total/500 cc | | |

Citrus Trees:

Inoculum of a bacterial species, preferably Bacillus, and more preferably Bacillus chitinosporus, was prepared having a preferred cell density of 1.0×10⁹ CFU/ml. To the bacteria inoculum, 0.1-10% chitosan-chitin based material, preferably 2.5% chitosan, was mixed to form a composition in accordance with Examples 1-6. The composition was applied to citrus plants. Initial experiments indicated application of the composition had the effect of reducing nematode loads, see Table 6.

TABLE 10
Effect of the composition on two species of
nematode species: citrus plants.

| Nematode Species | Pretreatment | Post-treatment |
|---|---|---|
| Tylenchulus | 764 | 8 |
| semipenetrans (Citrus | | |
| nematode) | | |
| Dagger | 83 | 0 |
| (nematodes of genus | | |
| Xiphinema) | | |

As shown in Table 10, two nematode species were tested, Tylenchulus semipenetrans (Citrus nematode) and Daggar nematodes. The numbers of Citrus nematode detected decreased when the grove was treated with the composition. The numbers of Dagger nematodes also decreased post-treatment.

All patents and publications mentioned in this specification are indicative of the levels of those skilled in the art to which the invention pertains. All patents and publications are herein incorporated by reference to the same extent as if each individual publication was specifically and individually indicated to be incorporated by reference.

It is to be understood that while a certain form of the invention is illustrated, it is not to be limited to the specific form or arrangement herein described and shown. It will be apparent to those skilled in the art that various changes may be made without departing from the scope of the invention and the invention is not to be considered limited to what is shown and described in the specification and any drawings/figures included herein.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. A composition for preventing or minimizing plant disease comprising:
at least one microbial strain with chitinase activity; and
a substrate that stimulates production of chitinase enzyme, which in combination with said at least one microbial strain, prevents or minimizes plant or crop disease.

2. The composition for preventing or minimizing plant disease according to claim 1 wherein said at least one microbial strain with chitinase activity and said substrate that stimulates production of chitinase enzyme are in effective amounts for inhibiting or killing at least one species of nematodes.

3. The composition for preventing or minimizing plant disease according to claim 1 wherein said at least one microbial strain with chitinase activity is a bacterial strain of Bacillus.

4. The composition for preventing or minimizing plant disease according to claim 1 wherein said bacterial strain of Bacillus is Bacillus chitinosporus.

5. The composition for preventing or minimizing plant disease according to claim 1 wherein said substrate that stimulates production of chitinase enzyme is a chitosan-chitin based material.

6. The composition for preventing or minimizing plant disease according to claim 3 wherein said bacterial strain of Bacillus is at a cell density of at least 1.0×10⁶ CFU/ml.

7. The composition for preventing or minimizing plant disease according to claim 3 wherein said bacterial strain of Bacillus is at a cell density of between 1.0×10⁶ CFU/ml and 1.0×10⁹ CFU/ml.

8. The composition for preventing or minimizing plant disease according to claim 5 wherein said chitosan-chitin based material is at a concentration of between 0.1% and 10%.

9. The composition for preventing or minimizing plant disease according to claim 1 wherein said composition is in a liquid form or a soluble, dry powder form.

10. A method of preventing or minimizing plant disease comprising:
applying an effective amount of a composition to a plant or plant component to minimize or prevent plant or crop disease, said composition comprising at least one microbial strain with chitinase activity; and a substrate that stimulates production of chitinase enzyme.

11. The method of preventing or minimizing plant disease according to claim 10 further including the steps of:
monitoring said plant or plant component for improvement of plant disease; and
reapplying said composition if necessary for treatment of said plant disease in said plant or plant component.

12. The method of preventing or minimizing plant disease according to claim 10 wherein application of said composition reduces the number of nematode species associated with said plant or plant component.

13. The method of preventing or minimizing plant disease according to claim 10 wherein said at least one microbial strain with chitinase activity is Bacillus chitinosporus.

14. The method of preventing or minimizing plant disease according to claim 10 wherein said substrate that stimulates production of chitinase enzyme is a chitosan-chitin based material.

15. The method of preventing or minimizing plant disease according to claim 13 wherein said Bacillus chitinosporus is at a cell density of at least 1.0×10⁶ CFU/ml.

16. The method of preventing or minimizing plant disease according to claim 13 wherein said Bacillus chitinosporus is at a cell density of between 1.0×10⁶ CFU/ml and 1.0×10⁹ CFU/ml.

17. The method of preventing or minimizing plant disease according to claim 14 wherein said chitosan-chitin based material is at a concentration of between 0.1% and 10%.

18. The method of preventing or minimizing plant disease according to claim 10 wherein said composition is applied in a liquid form or a soluble, dry powder form.

19. A composition for preventing or minimizing plant disease associated with nematodes comprising:
an isolated or purified bacterial strain of Bacillus chitinosporus; and
a chitosan-chitin based material, which in combination with said Bacillus chitinosporus kills or prevents the growth of at least one nematode species associated with plant disease.
